(19) United States
(12) Patent Application Publication
(10) Pub. No.: US 2012/0173603 A1
(43) Pub. Date: Jul. 5, 2012

(54) INFORMATION COMMUNICATION SYSTEM AND PORTABLE INFORMATION DEVICE

(75) Inventor: Atsuo Okamoto, Kanagawa (JP)

(73) Assignee: SONY CORPORATION, Tokyo (JP)

(21) Appl. No.: 13/333,049

(22) Filed: Dec. 21, 2011

(30) Foreign Application Priority Data
Dec. 29, 2010 (JP) P2010-294457

(51) Int. Cl. G06F 15/16

(52) U.S. Cl. 709/201

(57) ABSTRACT

An information communication system includes a product registration server which registers product information so as to correspond with user information, a portable information apparatus which has an Internet shortcut file which includes the URL of the product registration server and the product information, and an information processing device which activates a browser based on the read-out Internet shortcut file when externally connected to portable information apparatus and accesses the product registration server.

### CROSS-REFERENCE TO RELATED APPLICATION

The present application claims priority from Japanese Patent Application No. JP 2010-294457 filed in the Japanese Patent Office on Dec. 29, 2010, the entire content of which is incorporated herein by reference.

### BACKGROUND

The present disclosure relates to an information communication system and a portable information apparatus where product information of an information device purchased by a user is registered online, and in particular, relates to an information communication system and a portable information apparatus where product information is uploaded from a PC connected to the information apparatus via a cable.

In recent times, small information apparatuses such as digital cameras, portable music players, and the like have become widespread. This type of apparatus is often provided with an internal memory and a USB (Universal Serial Bus) interface and USB connection to a host apparatus such as a personal computer (PC) is possible. That is, the small information apparatus autonomously performs recording of images in the internal memory, reproducing of data from the internal memory, or the like in a state when there is no USB connection and operates as a USB device when there is a USB connection. In the latter case, it is possible for the internal memory of the small information apparatus to be simply recognized as a USB mass storage and to be accessed using a USB mass storage class from the USB host, such as a PC, which is the connection target. In addition, there is a state during the USB connection where the operation of the small information apparatus itself is stopped (in other words, a state where access to the internal memory is not possible).

In addition, most recently, there are many apparatuses where production registration with a manufacturer or a distributor is performed after being sold. The main aim of the product registration is to provide services related to the product such as distribution of applications related to the product and updating the firmware version of the product. In a case of registering online, it is possible to remotely provide a service via the Internet or the like.

For example, there is a proposal with regard to an operation software distribution service system where information relating to a household appliance which is used via a mobile phone is acquired from the household appliance, an operation program for the household appliance is acquired from a household appliance servicing firm, and setting of the environment and operation of the household appliance is performed via the mobile phone which acquires the various types of information (for example, refer to Japanese Unexamined Patent Application Publication No. 2003-78971).

The small information apparatus online registration procedure is typically realized using, for example, a PC application. Specifically, a user performs a USB connection of the small information apparatus with a PC which is connected to the Internet and performs an operation where the PC application which performed the product registration procedure (referred to below as a “registration application”) is activated. Then, when the registration application is activated, the PC performs initialization and control of a user interface for country and region selection and for language selection. Next, there is USB communication with the small information apparatus which is USB connected and a USB device descriptor is returned from the small information apparatus. In this manner, when a product serial number and other information which is necessary for product registration are acquired from the small information apparatus, the PC processes the data and uploads the product registration information when accessing a predetermined website such as that of a manufacturer or a distributor.

It is possible for the manufacturer or the distributor of the small information apparatus to provide a registration application to a user by, for example, storing the registration application in the memory in the small information apparatus. When the small information apparatus is USB connected to a PC, the small information apparatus is recognized as a USB mass storage device by the PC (as described above). Accordingly, it is possible for the PC to load the registration application from the USB mass storage and activate the registration procedure.

In recent times, two platforms of Windows (registered trademark) and Mac are in widespread use and it is necessary to develop application programs with the same functions for the separate platforms. As a result, it is necessary for the manufacturer or the distributor of the small information apparatus to prepare a Windows (registered trademark) edition and a Mac edition of the registration application and the burden of the development cost increases. In addition, in order to handle information which is not regulated by the USB standard, it is necessary to configure a unique arrangement.

In addition, the data size of the registration application is approximately 10 MB, and when the two versions of the registration application are stored in the internal memory of the small information apparatus, 20 MB of the memory capacity is used and there is a concern that the memory capacity may be exceeded. As a result, it is often the case that a CD-ROM where the registration applications for the separate platforms are recorded is distributed by being packaged with the small information apparatus. As a result, when registering online, it is burdensome since it is necessary that a user also prepare the CD-ROM along with simply USB connecting the small information apparatus to a PC. This burden is considered to be a cause which reduces the registration rate.

In addition, after the product information is acquired from the small information apparatus by the PC using USB communication, there is a concern that falsified product information may be registered by the addition of a falsified serial number or the like.

Of course, a primitive method may be considered where paper, on which the product serial number and the URL of the product registration site are printed, is packaged with the product and the registration procedure is performed through a user inputting the URL and the product registration information into a browser screen without relying on the PC application. However, this is an operation which is burdensome for the user and there is a limit to the amount of information which is able to be input. In addition, there is a problem with the accuracy of the information due to input mistakes and the like.

### SUMMARY

It is desirable to provide a superior information communication system and portable information apparatus which are able to appropriately upload product information from a PC connected to the information apparatus via a cable.

It is also desirable to provide a superior information communication system and portable information apparatus which are able to upload product information from a PC connected to the information apparatus via a cable according to a simple user operation which does not depend on a PC platform without burdening a memory capacity of the information apparatus.

An information communication system according to an embodiment of the present disclosure is provided with a product registration server which registers product information so as to correspond with user information, a portable information apparatus which has an Internet shortcut file which includes the URL of the product registration server and the product information, and an information processing device which activates a browser based on the read-out Internet shortcut file when externally connected to the portable information apparatus and accesses the product registration server.

Here, the “system” referred to here refers to a logical collection of a plurality of devices (or functional modules which realize a predetermined function) irrespective of whether or not each of the devices or function modules are in the same housing.

In the information communication system according to the embodiment of the present disclosure, the Internet shortcut file may include a check code of the product information and the product registration server may be configured so as to perform the product information registration after authenticity has been confirmed on the basis of the check code.

In the information communication system according to the embodiment of the present disclosure, the Internet shortcut file may include operation information code which indicates an intention of a user to add a function to the portable information device and the product registration server may be configured so as to transfer a software module which adds a function, where the intention to add the function is indicated in the operation information code, to the information processing device so as for the information processing device to transfer the received software module to the portable information apparatus.

In the information communication system according to the embodiment of the present disclosure, the product registration server may be configured so as to limit the number of times a service is provided to the portable information apparatus.

In the information communication system according to the embodiment of the present disclosure, the Internet shortcut file may include a time stamp and the product registration server may be configured so as to limit the number of times the service is provided to the portable information apparatus based on the time stamp.

A portable information apparatus according to another embodiment of the present disclosure is provided with a connection interface which is externally connected to an information processing device, a first internal memory which stores the URL of the product registration server and product information and which is not able to be accessed by the information processing device via the connection interface, a second internal memory which is able to be accessed by the information processing device via the connection interface, and a processing section which generates an Internet shortcut file on the basis of the URL of the product registration server and the product information which are stored in the first internal memory, stores the Internet shortcut file in the first internal memory, and copies the Internet shortcut file in the first internal memory into the second internal memory in response to the information processing device being connected to the connection interface.

The processing section of the portable information apparatus according to the other embodiment of the present disclosure may be configured so as to generate a check code of the product information and include the check code in the Internet shortcut file.

The processing section of the portable information apparatus according to the other embodiment of the present disclosure may be configured so as to include an operation information code which indicates an intention to add a function in the Internet shortcut file.

The processing section of the portable information apparatus according to the other embodiment of the present disclosure may be configured so as to include a time stamp in the Internet shortcut file.

The processing section of the portable information apparatus according to the other embodiment of the present disclosure may be configured so as to update the Internet shortcut file in the first internal memory when the Internet shortcut file is not placed in the second internal memory or when the size or the time stamp of the Internet shortcut file which is already placed in the second internal memory is different from the Internet shortcut file stored in the first internal memory.

According to the embodiments of the present disclosure, it is possible to provide a superior information communication system and portable information apparatus which are able to upload product information from a PC connected to the information apparatus via a cable according to a simple user operation which does not depend on a PC platform without burdening a memory capacity of the information apparatus.

According to the embodiments of the present disclosure, along with the URL for accessing a product registration site, a product serial number, a check code which verifies the authenticity of the serial number, information according to services, and the like are built into a file with a small capacity which is an Internet shortcut for product registration and are stored in a USB mass storage region in an internal memory of the portable information apparatus. Then, when the portable information apparatus is USB connected to a PC, if the Internet shortcut file is clicked directly from the PC or via a user interface, it is possible to register information relating to a product to a server by uploading the product information to the server via a browser or receive services such as the updating of functions of the portable information device from the server.

Other further aims, characteristics, and advantages of the present embodiment will be made clear by a more detailed description which is based on the embodiments of the present disclosure and the attached diagrams which will be described later.

### BRIEF DESCRIPTION OF THE DRAWINGS

FIG. 1 is a diagram schematically illustrating one example of an information communication system where product information of an information apparatus which was purchased by a user is registered online;

FIG. 2 is a diagram illustrating a description example of an Internet shortcut file for product registration;

FIG. 3 is a diagram illustrating a configuration example of an album screen;

FIG. 4 is a diagram illustrating a configuration example of a menu screen of Device Stage;

FIG. 5 is a diagram for describing a flow where product registration of a digital camera is performed using an Internet shortcut file for product registration;

FIG. 6 is a flowchart illustrating a process sequence which places information which is necessary for generating of an Internet shortcut file for product registration in an internal memory of a digital camera when manufacturing;

FIG. 7 is a flowchart illustrating a process sequence for generating an Internet shortcut file for product registration using firmware processing in a digital camera;

FIG. 8 is a flowchart illustrating a process sequence where up to a check code is placed in an internal memory of a digital camera when manufacturing;

FIG. 9 is a flowchart illustrating a process sequence for generating an Internet shortcut file for product registration from information stored in an internal memory using the process sequence shown in FIG. 8 using firmware processing in a digital camera;

FIG. 10 is a flowchart illustrating a process sequence for generating an Internet shortcut file for product registration which includes an operation information code of a user from information stored in an internal memory using the process sequence shown in FIG. 6 using firmware processing in a digital camera;

FIG. 11 is a flowchart illustrating a process sequence for generating an Internet shortcut file for product registration which includes a time stamp code from information stored in an internal memory using the process sequence shown in FIG. 6 using firmware processing in a digital camera;

FIG. 12 is a flowchart illustrating a process sequence for placing an Internet shortcut file for product registration in an internal memory (a region which becomes USB mass storage when there is a USB connection) of a digital camera;

FIG. 13 is a flowchart illustrating a process sequence which is performed by a production registration server when a request is redirected from a sorting server;

FIG. 14A is a diagram illustrating a communication sequence example for distributing a software module from a production registration server to a digital camera;

FIG. 14B is a diagram illustrating a communication sequence example for distributing a software module from a production registration server to a digital camera;

FIG. 15 is a flowchart illustrating a process sequence for a PC to use an Internet shortcut file for product registration using a PC application built into a camera;

FIG. 16 is a flowchart illustrating a process sequence for a PC to use an Internet shortcut file for product registration using a Device Stage function on Windows (registered trademark);

FIG. 17 is a diagram schematically illustrating a hardware configuration of a digital camera; and

FIG. 18 is a diagram schematically illustrating a hardware configuration of a PC.

### DETAILED DESCRIPTION OF EMBODIMENTS

Below, embodiments of the present disclosure will be described in detail while referencing the diagrams.

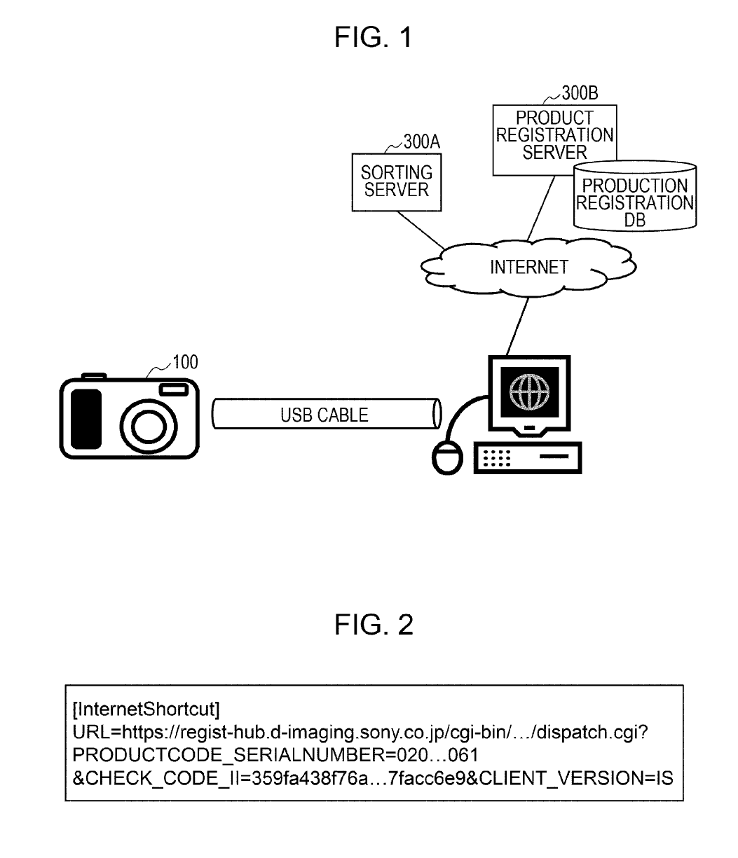

FIG. 1 schematically illustrates one example of an information communication system where product information of an information apparatus which was purchased by a user is registered online. The information communication system 1 of the diagram is formed from a small information apparatus 100 which is purchased by a user, a PC 200, and servers 300A, 300B, . . . on the Internet.

One example of the small information apparatus 100 is a digital camera and a USB connection as a USB device is possible. The PC 200 does not depend on a platform, but is USB connected to the digital camera 100 and is normally connected to the Internet. The digital camera 100 during USB connection is recognized as USB mass storage by the PC 200. In the PC 200, various processes are executed by a browser being started and various types of applications being activated.

A sorting server 300A is able to be specified using the URL (Uniform Resource Locator) and is able to be accessed from the PC 200 via the browser. The sorting server 300A is a portal site which is, for example, constructed by a manufacturer or a distributor of various products such as a digital camera. For example, the sorting server 300A redirects a request to another server from a client such as the browser through a CGI (Common Gateway Interface). The client is able to transfer input data to the CGI using, for example, a GET method of HTTP (Hyper Text Transfer Protocol).

A product registration server 300B is one server which receives redirections from the sorting server 300A. The product registration server 300B registers product information such as a product serial number and user information so as to correspond in a product registration database in accordance with a product registration request which is redirected. The product registration server 300B is, for example, set up for each manufacturer or distributor.

The product registration server 300B provides services in related to a product such as distributing application software which functions in a PC related to the product (the digital camera 100) or in the product, updating the version of the firmware of the product, or the like with regard to a user which registered the product information.

However, it is not necessary for product registration to be performed by being redirected from the sorting server 300A such as a portal site to the product registration server 300B and a configuration is possible where there is a direct connection so that up until the registration procedure is performed at the initial site which is access from the browser of the PC 200.

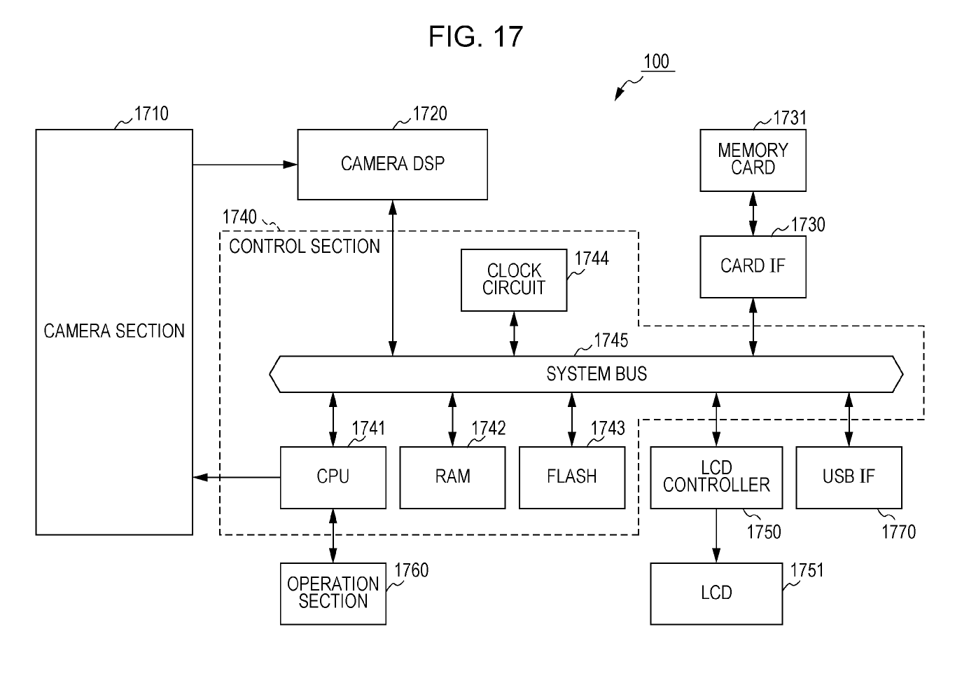

FIG. 17 schematically illustrates a hardware configuration of the digital camera 100 which is the small information apparatus. The digital camera 100 in the diagram is provided with a camera section 1710, a camera DSP (Digital Signal Processor) 1720, a card interface 1730, a memory card 1731, a control section 1740, an LCD (Liquid Crystal Display) controller 1750, an LCD 1751, an operation section 1760, and a USB interface 1770.

The camera section 1710 is provided with an optical block, an image sensor such as a CCD (Charge Coupled Device), a pre-processing circuit of imaging signals, a driver which drives the optical block and the CCD, a timing generation circuit which sends a timing signal to the driver, and the like (none of which are shown). The optical block is provided with, for example, a lens, a focus mechanism, a shutter mechanism, an iris mechanism, and the like. In addition, the pre-processing circuit forms digital image data by performing A/D conversion after processing such as CDS (Correlated Double Sampling), AGC (Automatic Gain Control), and the like are performed with regard to an imaging signal which is supplied from the image sensor.

The camera DSP 1720 carries out camera signal processing such as AF (Auto Focus), AE (Auto Exposure), AWB (Auto White Balance) with regard to image data, encodes the data using a predetermined coding method such as JPEG (Joint Photographic Experts Group), and records the encoded data as a file to the memory card 1731 via a system bus 1745 and the card interface 1730. In addition, the camera DSP 1720 decodes the image data which is read out from the memory card 1731 via the system bus 1745 and the card interface, and supplies the image data to the LCD controller 1750. The LCD controller 1750 displays an image on a display screen of the LCD 1751 by forming an image signal from the image data which is supplied.

The control section 1740 is configured so that a CPU (Central Processing Unit) 1741, a RAM (Random Access Memory) 1742, a flash ROM (Read Only Memory) 1743, and a clock circuit 1744 are connected via a system bus 1745. The control section 1740 controls each section of the digital camera 100 in accordance with, for example, instructions from a user which is input into the operation section 1760. Here, the RAM 1742 is mainly used as a working region such as for temporarily storing in-progress results of processing. In addition, the flash ROM 1743 stores various programs such as firmware which is executed in the CPU 1741, data which is necessary for processing, information which is necessary for product registration such as the product serial number, and the like. In addition, it is possible that the clock circuit 1744 measures the current time and provides an imaging time and date or time stamp information.

The digital camera 100 is provided with a USB interface 1770 and is able to be USB connected to the PC 200 and the like. When there is a USB connection, the digital camera 100 becomes a USB device and is in a state where the control section 1740 stops operation and access to the memory card 1731 is not possible.

In addition, when referring below to the “internal memory” of the digital camera 100, the internal memory is equivalent to both the memory card 1731 and the flash ROM 1743 in the control section 1740. However, the memory card 1731 is recognized by the PC 200 as USB mass storage, but the flash ROM 1743 is not recognized as USB mass storage. A master of an Internet shortcut file which will be described later is stored in the flash ROM 1743 and the master is copied to the memory card 1731 using firmware processing or the like. In addition, a PC application such as album software which will be described later is recorded in the memory card 1731.

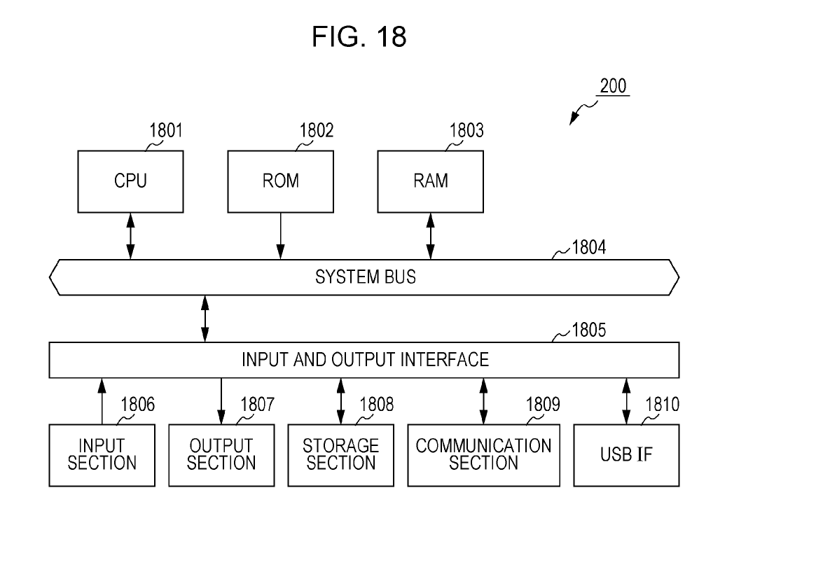

FIG. 18 schematically illustrates a hardware configuration of the PC 200. The various types of servers 300A, 300B, . . . have the same configuration.

A CPU 1801, a ROM 1802, and a RAM 1803 are connected to each other using a bus 1804. An input and output interface 1805 is connected to the bus 1804. The input and output interface 1805 is connected to an input unit 1806 which is formed by a keyboard, a mouse, a microphone or the like, an output unit 1807 which is formed by a display, a speaker or the like, a storage unit 1808 which is formed by a hard disk, a nonvolatile memory or the like, a communication unit 1809 which is formed by a network interface or the like, and a USB interface 1810. The PC 200 is connected to an external network such as the Internet in accordance with a predetermined communication protocol via a communication section 1809. In addition, it is possible for the PC 200 to be connected to a USB device such as the digital camera 100 through the USB interface 1810.

In the PC 200, the CPU 1801 performs the series of processes described above, for example, using a program stored in the storage section 1808 being loaded into the RAM 1803 via the input and output interface 1805 and the bus 1804 and executed. As the program which is loaded from the storage section 1808, an operating system such as Windows (registered trademark) or Mac and various applications such as a browser or a server application are possible. In addition, it is possible for a PC application (which will be described later) such as album software, which is stored in the USB mass storage in a USB device which is connected via the USB interface 1810, to be executed by the CPU 1801 in the same manner by being loaded onto the RAM 1803.

When the procedure of product registration of the digital camera 100 is realized using an application on the PC 200, the burden increases with regard to the manufacturer or the distributor as well as the user since, for example, it is necessary to prepare CD-ROMs and it is necessary that the application is developed for separate platforms. Therefore, the inventors propose a method which performs product registration such as the uploading of product related information using an Internet shortcut file instead of a PC application.

Here, the Internet shortcut file itself is a (common) file format which has an extension “url” which is used as a bookmark in a browser such as “favorites” in Internet Explorer. The Internet shortcut file is a data file formed from a string of characters which is described in accordance with a predetermined expression format such as a URL. The URL is basically configured by combining various character strings of scheme name such as “http”, “https”, “ftp”, and the like, a host name such as “****.com”, “****.co.jp”, or the like, and a path name such as a directory name when necessary. In addition, at the end of the URL, it is possible to further combine a character string which expresses instruction on processing using the CGI or the like and a character string which expresses data which is transferred to the CGI. The character string which expresses data which is transferred to the CGI is described in accordance with a writing method which uses HTTP GET, HTTP POST, or the like.

In the embodiment, the Internet shortcut for product registration is configured by the various character strings of a scheme name such as “http”, “https”, or the like, a host name for specifying a portal site such as the sorting server 300A, an instruction for product registration processing with regard to the server which receives the redirection such as the product registration server 300B, and information which is transferred to the server which receives the redirection.

The processing which is requested of the product registration server 300B is able to be instructed via the CGI. The information which is transferred to the CGI is information related to product information, and in the embodiment, is described using a writing format which follows HTTP GET. Product identification information such as a product serial number and a check code for verifying the authenticity of the product serial number are necessary as information related to the product registration. The check code is able to be calculated by, for example, applying a hash function to the serial number.

As the information related to the product registration which is transferred to the CGI, it is possible to further include an operation information code which indicates an intention to add a function to the digital camera 100, a time stamp, or the like. Here, the including of operation information code is limited to products which are able to add a function to the firmware. In addition, the time stamp is used as information for limiting the number of times or frequency that a service is provided with regard to the product. In a case where the operation information code and the time stamp are embedded in the URL, the calculation of the check code is performed with regard to a character string where the operation information code and the time stamp have been added to the serial number.

FIG. 2 illustrates a description example of the Internet shortcut file for product registration. In FIG. 2, “https” is the scheme name, “regist-hub.d-imaging.sony.co.jp” is the host name, and “cgi-bin/ . . . /dispatch.cgi?” is a processing instruction to the server which receives the redirection and there is description using CGI. Then, “PRODUCTCODE SERIALNUMBER=020_{—}061” is the product serial number which is to be registered and “CHECK_CODE_II=359fa438f76a . . . 7facc6e9” is the check code which is calculated from the serial number described above using the hash function.

The data size of the Internet shortcut file for product registration is at most approximately a few tens of KB and the burden on memory capacity is low even if stored in the internal memory of a digital camera. When the digital camera 100 is USB connected to the PC 200, the digital camera 100 is recognized as one USB mass storage by the PC 200 and it is accessible using the USB mass storage class. The Internet shortcut file for product registration may be, for example, displayed on a screen (Explorer or Finder) of the PC 200 as one file icon in a folder of the USB mass storage and may be found and clicked on by the user. The Internet shortcut file itself is able to be used in product registration on any platform since it does not depend on any platform such as Windows (registered trademark) or Mac.

In addition, a user interface may be provided which leads a user to the product registration procedure instead of performing the product registration procedure by a direct operation which is lead by the user such as the user searching for and clicking an icon of the Internet shortcut file for product registration in the Explorer screen on Windows (registered trademark) or the Finder screen on Mac.

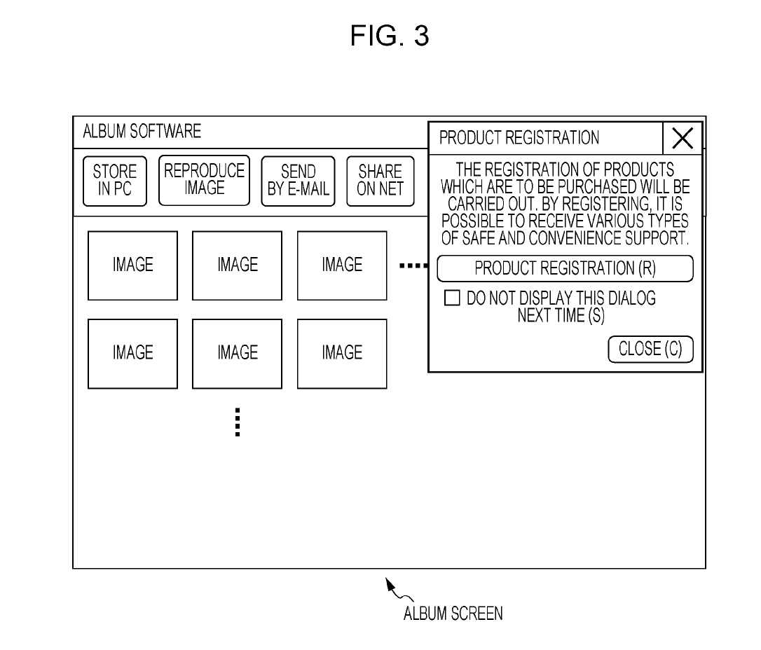

For example, album software is stored as one PC application in the camera along with the Internet shortcut file in the internal memory of the digital camera 100. The album software is activated by being loaded into the PC 200 when the PC 200 is USB connected, but the main function is the performing of arranging, managing, editing, and processes such as transferring by mail and uploading to the web of the captured images which are stored in the internal memory and the like. FIG. 3 illustrates a configuration example of an album screen which displays a display on the PC 200. The album screen is basically a list of captured images and includes a tool bar which is provided with tool buttons such as “store in PC”, “reproduce image”, “send by mail”, and the like. When the album software is opened, a product registration dialog is displayed as a pop-up. In this case, the process of searching for the icon of the Internet shortcut file for product registration is performed by the album software. Then, when the “product registration (R)” button in the dialog is selected, the browser is activated and a process is executed where there is access to the sorting server 300A and the product related information is registered in accordance with the URL character string which is described in the Internet shortcut file. In addition, the album software may add a GET parameter of the URL character string to setting information such as the country and region code or the language code which are set in the software (that is, this setting information is added to the product registration related information) or another process which changes the product registration related information may be performed.

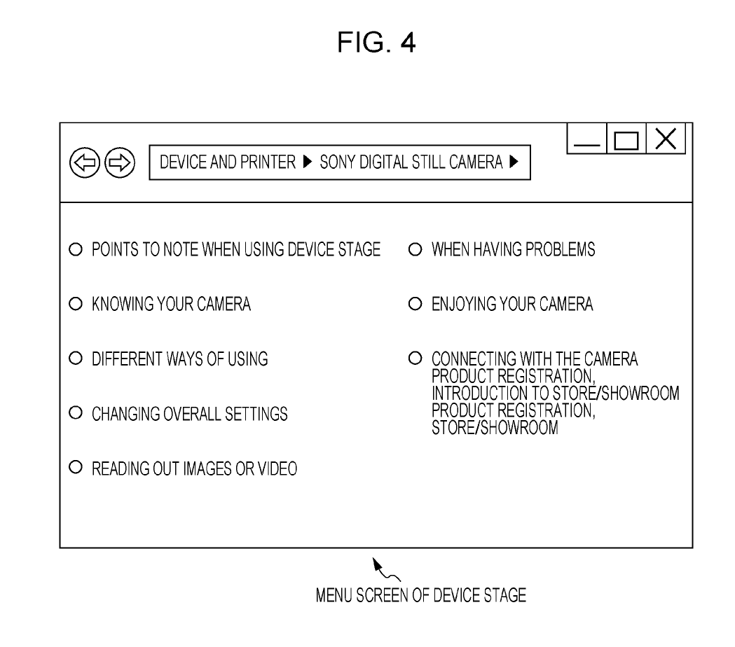

In addition, in Windows (registered trademark) 7, a function called “Device Stage” is installed where a menu is provided for dealing collectively with various peripheral devices which are connected to the PC 200. FIG. 4 illustrates a configuration example of a menu screen of Device Stage. On the menu screen, a “product registration” anchor is provided as an item which relates to the connected camera. In this case, the process of searching for the icon of the Internet shortcut file for product registration is performed by Device Stage. Then, when the anchor is selected, the browser is activated and a process is executed where there is access to the sorting server 300A and the product related information is registered in accordance with the URL character string which is described in the Internet shortcut file.

As is understood from the description of FIGS. 3 and 4, according to the method where product registration is performed using the Internet shortcut file, it is possible to easily install a user interface which leads a user to product registration.

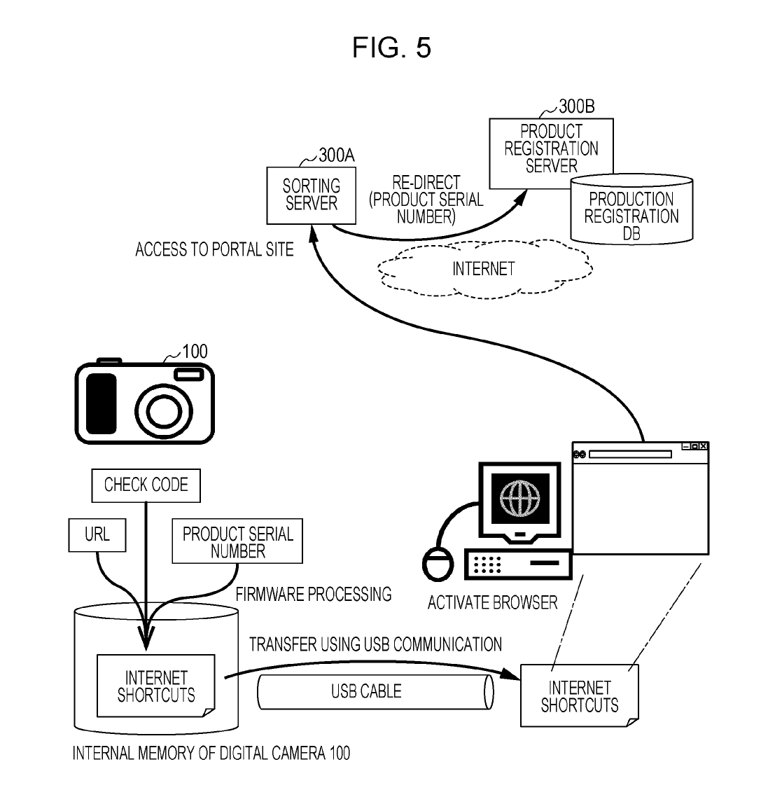

FIG. 5 illustrates a flow where product registration of the digital camera 100 is performed using the Internet shortcut file for product registration.

A unique product serial number is allocated to the digital camera 100. The check code is created from the product serial number using a predetermined hash function. Then, an Internet shortcut file is generated by combining the character strings of the product serial number and the check code in the URL of the sorting server 300A and is stored in the internal memory. The process of generating of the Internet shortcut file may be performed at a factory before shipping of the digital camera 100 or may be performed using firmware processing in the digital camera 100.

In the PC 200 which is USB connected to the digital camera 100, the internal memory is recognized as USB mass storage. Then, when the user searches for and clicks on the icon of the Internet shortcut file for product registration in the Explorer screen of Windows (registered trademark) or the Finder screen of Mac, the browser is activated and a process is executed where there is access to the sorting server 300A and the product related information is registered in accordance with the URL character string which is described in the Internet shortcut file. The clicking on the icon is equivalent to selecting the “product registration (R)” button in the product registration dialog which is displayed as a pop-up and the selection of the “product registration” anchor in the Device Stage menu.

The browser which is activated on the PC 200 transmits a request to the sorting server 300A in accordance with the scheme name “https” and the host name “regist-hub.d-imaging.sony.co.jp” in the URL character string.

The sorting server 300A interprets a processing instruction which is combined after the host name in the URL character string which is included in the request and redirects the product registration process to the product registration server 300B via the CGI. At this time, information related to product registration such as the product serial number is combined with the check code in the URL. These character strings are described in accordance with the HTTP GET writing method and transferred to the CGI when redirecting.

When the product registration process is redirected, the product registration server 300B registers the product information and the user information so as to correspond in the product registration database when the information related to the product registration such as the product serial number is received. In addition, before registration, the authenticity of the registered information is checked by a check code being generated and compared against the received check code.

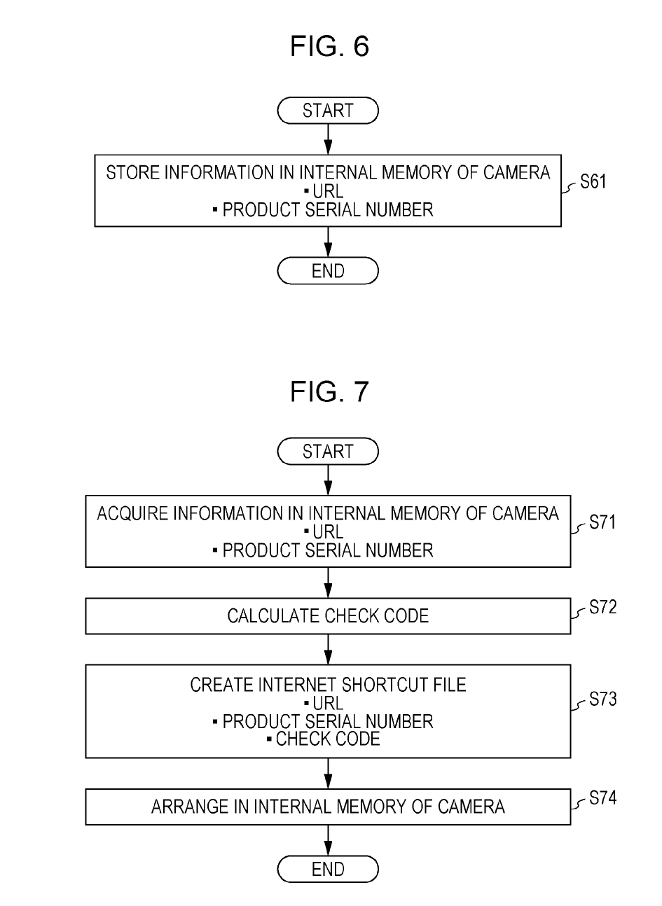

FIG. 6 illustrates a process sequence in a flowchart format where information which is necessary for generating of the Internet shortcut file for product registration is placed in an internal memory of the digital camera 100 when manufacturing.

In this case, a basic URL character string formed from a scheme name and a server name for accessing the sorting server 300A and the product serial number are stored in the internal memory of the digital camera 100 (step S61) and the process ends. The internal memory referred to here is a region such as the flash ROM 1743 which does not become USB mass storage when there is a USB connection.

In addition, in a flowchart format, FIG. 7 illustrates a process sequence for generating an Internet shortcut file for product registration from information stored in the internal memory using the process sequence shown in FIG. 6 using firmware processing in the digital camera 100.

First, the basic URL character string formed from a scheme name and a server name and the product serial number, which are stored in the internal memory such as the flash ROM 1743, are read out (step S71).

Next, the check code is calculated by applying the predetermined hash function to the serial number (step S72).

Next, the Internet shortcut file is generated by the character strings of the serial number and the check code which was calculated in step S72 being combined to the end of the basic URL character string (step S73).

Then, the generated Internet shortcut file is placed in the internal memory of the digital camera 100 as a master (step S74) and the process routine ends. The internal memory referred to here is a region such as the flash ROM 1743 which does not become USB mass storage when there is a USB connection.

According to the process sequence described above, it is possible to reduce the opportunities for falsified registration since the process of generating the check code is not exposed to the outside of the product such as the digital camera 100 and is hidden from the user.

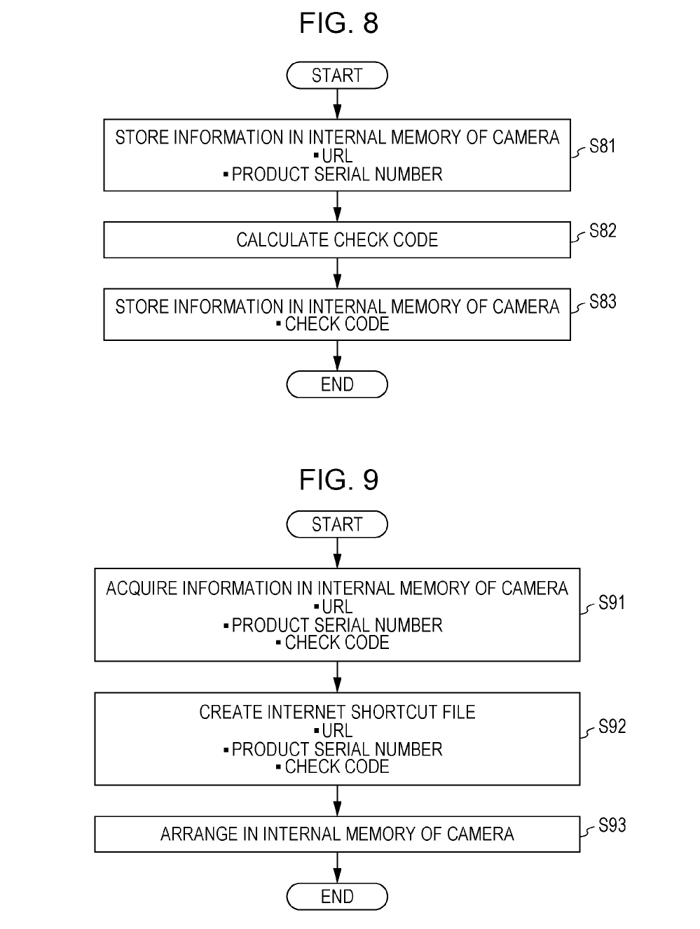

In addition, FIG. 8 illustrates a process sequence in a flowchart format where up to a check code is placed in an internal memory of a digital camera 100 when manufacturing.

First, the basic URL character string formed from a scheme name and a server name for accessing the sorting server 300A and the product serial number are stored in the internal memory of the digital camera 100 (step S81).

Next, the check code is calculated by applying the predetermined hash function to the product serial number using manufacturing equipment (step S82).

Next, the calculated check code is stored in the internal memory of the digital camera 100 (step S83) and the process ends. The internal memory referred to here is a region such as the flash ROM 1743 which does not become USB mass storage when there is a USB connection.

In addition, in a flowchart format, FIG. 9 illustrates a process sequence for generating the Internet shortcut file for product registration from the information stored in the internal memory using the process sequence shown in FIG. 8 using firmware processing in the digital camera 100.

First, the basic URL character string formed from a scheme name and a server name and the product serial number, which are stored in the internal memory, are read out along with the check code which is generated from the product serial number (step S91).

Next, the Internet shortcut file is generated by the character strings of the serial number and the check code which was calculated in step S91 being combined to the end of the basic URL character string (step S92).

Then, the generated Internet shortcut file is placed in the internal memory of the digital camera 100 as a master (step S93) and the process routine ends. The internal memory referred to here is a region such as the flash ROM 1743 which does not become USB mass storage when there is a USB connection.

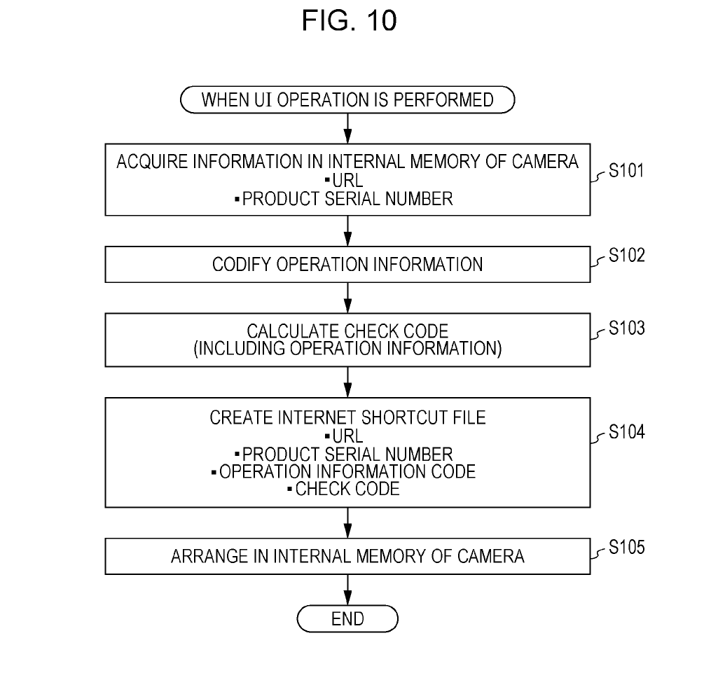

In addition, in a flowchart format, FIG. 10 illustrates a process sequence for generating the Internet shortcut file for product registration from information stored in the internal memory using the process sequence shown in FIG. 6 using firmware processing in the digital camera 100. The process sequence differs from the process sequence shown in FIG. 7 in the point that information related to a user operation which was performed with regard to the digital camera 100 is included in the Internet shortcut file.

The process sequence is activated in response to any operation being performed with regard to a user interface (UI) of the digital camera 100.

First, the basic URL character string formed from a scheme name and a server name and the product serial number which are stored in the internal memory are read out (step S101).

Next, the user operation information which was performed with regard to the digital camera 100 is encoded (step S102).

Next, the operation information code which is generated in step S102 is combined with the serial number and the check code is calculated by applying the predetermined hash function to the combination of the operation information code and the serial number (step S103).

Next, the Internet shortcut file is generated by the character strings of the serial number, the operation information code, and the check code which was calculated in step S103 being combined to the end of the basic URL character string (step S104).

Then, the generated Internet shortcut file is placed in the internal memory of the digital camera 100 as a master (step S105) and the process routine ends. The internal memory referred to here is a region such as the flash ROM 1743 which does not become USB mass storage when there is a USB connection. For example, a copy of the master of the Internet shortcut file is placed in a region of the internal memory which becomes the USB mass storage such as the memory card 1731 when the digital camera 100 is USB connected to the next PC 200.

According to the process sequence described above, it is possible to reduce the opportunities for fraudulent registration since the process of generating the check code is not exposed to the outside of the product such as the digital camera 100 and is hidden from the user (same as above).

In the execution of the process sequence shown in FIG. 10, a product, which is able to have a function added to the firmware by the addition of a software module, is the target. The digital camera 100 is provided with a user interface which inquiries to a user whether a software module is to be added (for example, a button where the function name is written is provided). The user indicates an intention of a desire to add a function by operating the user interface in this manner. Then, the digital camera 100 encodes the operation information in order to respond to the indication of intention, and the operation information is embedded in the Internet shortcut file and sent to the server.

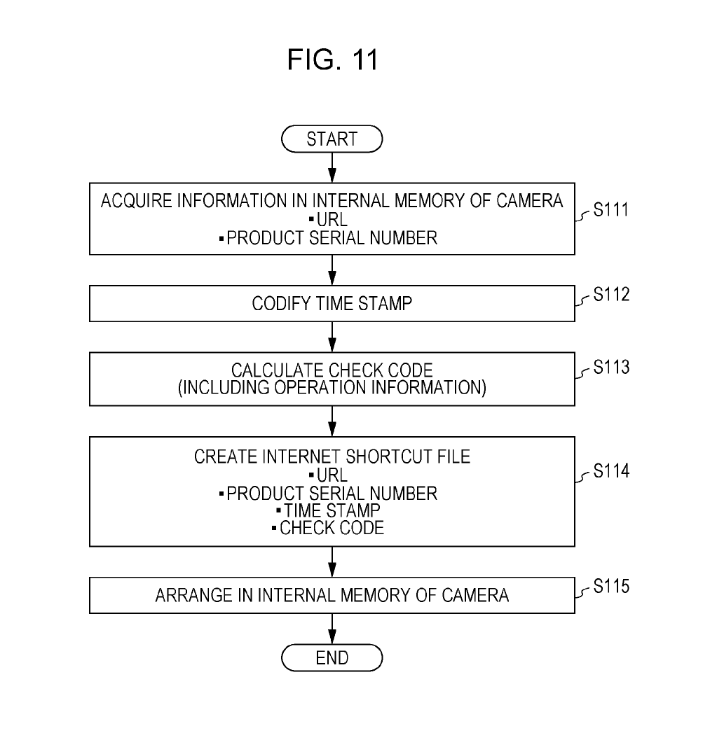

In addition, in a flowchart format, FIG. 11 illustrates a process sequence for generating an Internet shortcut file for product registration from information stored in the internal memory using the process sequence shown in FIG. 6 using firmware processing in the digital camera 100. The process sequence differs to the process sequence shown in FIG. 7 in the point that a time stamp is included in the Internet shortcut file.

It is desirable that the process sequence is to be activated at a time when the reception of a service from the product registration server 300B approaches such as when the user has performed an operation with regard to the digital camera 100 and when the PC 200 is USB connected.

First, the basic URL character string formed from a scheme name and a server name and the product serial number which are stored in the internal memory are read out (step S111).

Next, a time stamp where the time is measured in the digital camera 100 is encoded (step S112). It is possible for the time stamp to be acquired from the clock circuit 1744.

Next, the time stamp which is encoded in step S112 is combined with the serial number and the check code is calculated by applying the predetermined hash function to the combination of the time stamp and the serial number (step S113).

Next, the Internet shortcut file is generated by the character strings of the serial number, the time stamp code, and the check code which was calculated in step S113 being combined to the end of the basic URL character string (step S114).

Then, the generated Internet shortcut file is placed in the internal memory of the digital camera 100 as a master (step S115) and the process routine ends. The internal memory referred to here is a region such as the flash ROM 1743 which does not become USB mass storage when there is a USB connection. For example, a copy of the master of the Internet shortcut file is placed in a region of the internal memory which becomes the USB mass storage such as the memory card 1731 when the digital camera 100 is USB connected to the next PC 200.

According to the process sequence described above, it is possible to reduce the opportunities for falsified registration since the process of generating the check code is not exposed to the outside of the product such as the digital camera 100 and is hidden from the user (same as above).

In the process sequence shown in FIG. 11, it is possible to limit the number of copies of the Internet shortcut file as one usage of the including of the time stamp information in the Internet shortcut file. When unlimited copying of the Internet shortcut file is permitted, unlimited providing of services is able to be received from the product registration server 300B. Therefore, the unlimited providing of services is able to be avoided by the product registration server 300B controlling the service providing based on the time stamp. For example, it is possible to perform control such as (1) evaluating the time shown in the time stamp and invalidating old time stamps and (2) managing the serial number and the time stamp as a group and providing a service once for each time stamp.

Of course, the operation information code and the time stamp code may be embedded together in the Internet shortcut file in combination with the process sequence shown in FIG. 10 and FIG. 11.

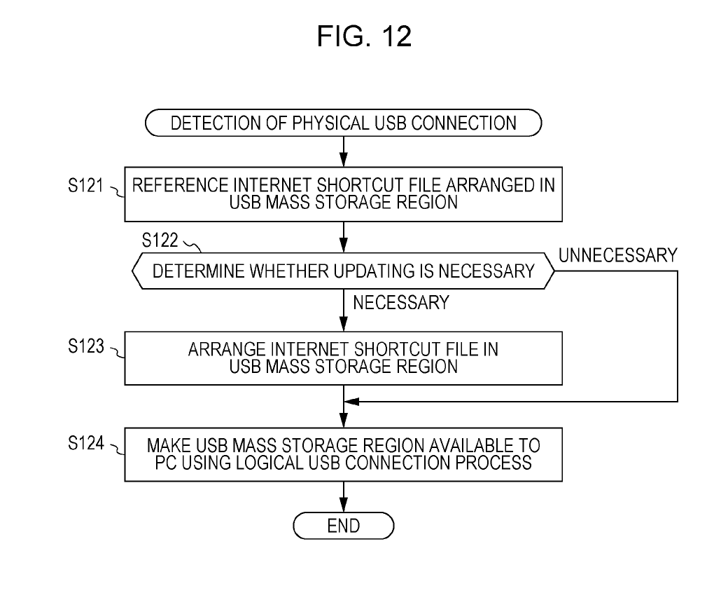

In the process sequence such as FIGS. 10 and 11, the generated Internet shortcut file for product registration is placed in a region of the internal memory which does not become USB mass storage when there is a USB connection (for example, the flash ROM 1743). Then, a copy of the master of the Internet shortcut file is placed in a region of the internal memory which becomes the USB mass storage such as the memory card 1731 when the digital camera 100 is USB connected to the next PC 200. In a flowchart format, FIG. 12 illustrates a process sequence for placing the master of the Internet shortcut file which is generated using the process sequence such as that of FIG. 10 or 11 in a region of the internal memory of the digital camera 100 which becomes USB mass storage when there is a USB connection.

The Internet shortcut file for product registration is placed in a region of the internal memory of the digital camera 100 which becomes USB mass storage when there is a USB connection. It is possible for the process sequence shown in FIG. 12 to be realized using firmware processing in the digital camera 100, and preferably, to be activated in response to the detection of a physical connection of the USB cable.

First, the Internet shortcut file which is placed in the USB mass storage region is referenced (step S121) and whether updating of the file is necessary is determined (step S122).

In step S122, updating is determined to be necessary in a case where the Internet shortcut file is not able to be found in the USB mass storage region and in a case where the size or the time stamp of the Internet shortcut file already placed in the USB mass storage region is different to the master. Here, the adding of falsified operations using malware and the like and the updating of the master due to a user operation or the like are considered as a cause of the size or the time stamp being different. In either case, it is understood that updating is necessary.

In a case where it is determined that the updating of the Internet shortcut file is necessary (Yes in step S122), the master of the Internet shortcut file is placed in the USB mass storage region of the internal memory (step S123) and the Internet shortcut file in the USB mass storage is updated.

Then, after the latest Internet shortcut file is updated in step S123 or when it is determined that updating is not necessary (No in step S122), the USB mass storage region is made available to the PC 200 via a further logical USB connection process with the PC 200 which is physically USB connected via the USB cable (step S124) and the process routine ends. Here, the sequence of the logical USB connection process is based on the USB standard and a detailed description is omitted since it is not directly related to the concept of the present disclosure.

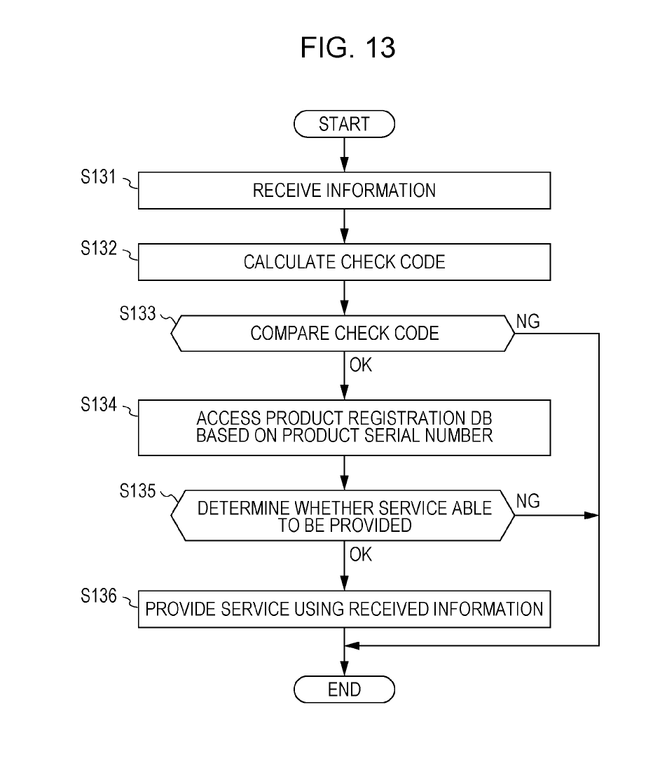

FIG. 13 illustrates a process sequence in a flowchart format which is performed by the production registration server 300B when a request is redirected from the sorting server 300A.

As already described, it is possible to transfer information to the CGI by the information being described in the URL character string in the Internet shortcut file in accordance with the HTTP GET writing method.

When receiving the information and the check code from the sorting server 300A (step S131), the product registration server 300B generates the check code from the received information (step S132). Then, there a comparison of whether the check code which is generated by the product registration server 300B and the received check code match (step S133).

Here, when the check codes do not match (NG in step S133), the registration procedure is stopped as the received information is considered to be falsified data and the process routine ends.

On the other hand, when the check codes do match (OK in step S133), the product registration database is accessed using the serial number which is included in the received information (step S134) and it is determined whether or not the service is to be provided with regard to the digital camera 100 which is the origin of the request (step S135). In the product registration database, whether or not the providing of the service has been completed is managed for each product using the time stamp or the like.

When it is determined that the service is not to be provided due to a reason such as the service has already been provided (NG in step S135), the providing of the service is not performed and the process routine ends.

In addition, when it is determined that it is suitable to provide the service (OK in step S135), the providing of the service is performed with regard to the digital camera 100 using the received information (step S136). For example, when the information related to the product registration is received, the product information and the user information is registered so as to correspond in the product registration database.

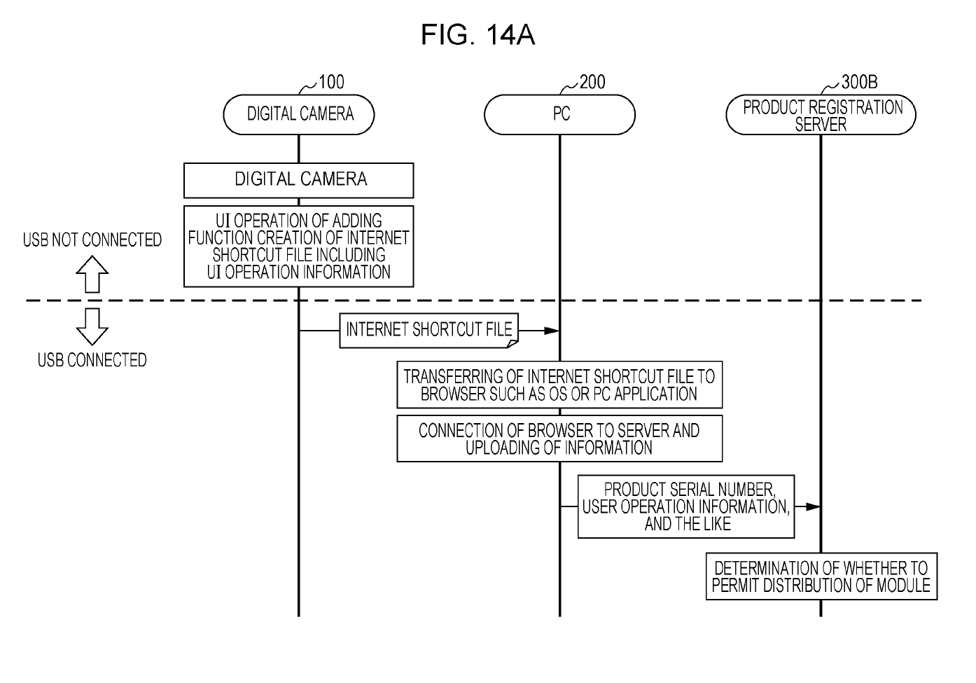

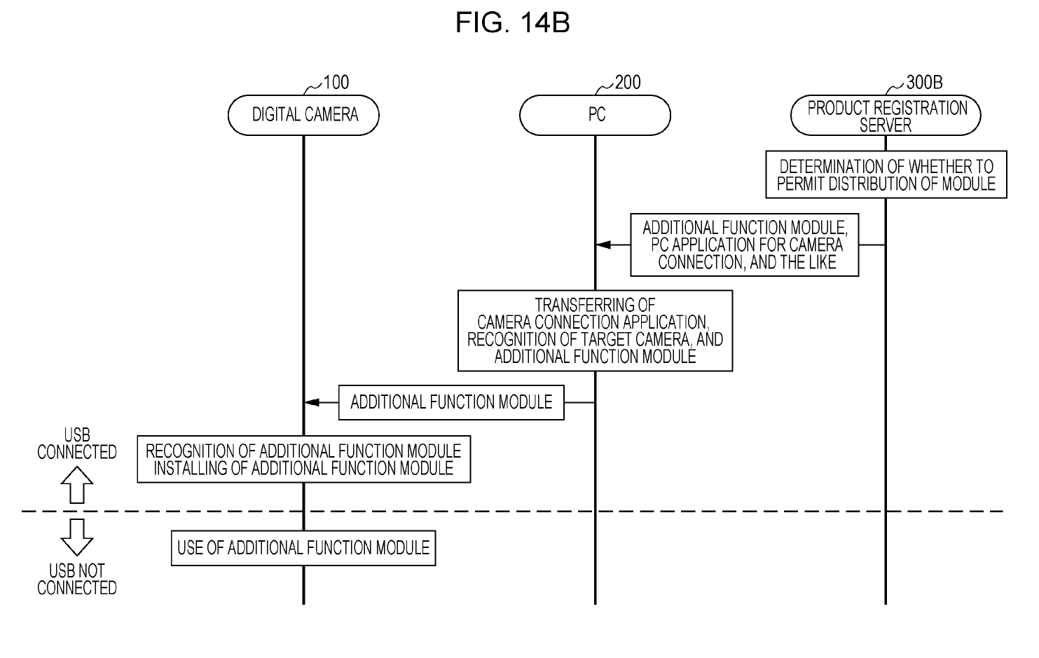

The embedding of the operation information code, which indicates the intention of adding a function using the adding of a software module, in the Internet shortcut file has already been described while referencing FIG. 10. FIGS. 14A and 14B are diagrams illustrating a communication sequence example for distributing a software module from the production registration server 300B to the digital camera 100. Here, in the diagrams, the sorting server 300A which redirects the request is omitted for simplification of the diagrams.

First, a first half of the sequence will be described while referencing FIG. 14A. The user performs an operation for indicating an intention to add a function to the firmware using the adding of a software module with regard to the user interface (UI) of the digital camera 100 when there is no USB connection.

By doing this, the Internet shortcut file which includes the operation information code corresponding to the user operation is generated in accordance with, for example, the process sequence shown in FIG. 10 using firmware processing in the digital camera 100.

The Internet shortcut file is placed in the USB mass storage region when the digital camera 100 is physically USB connected to the PC 200. Furthermore, the Internet shortcut file in the USB mass storage region is made available to the PC 200 via a logical USB connection process.

In the PC 200, the Internet shortcut file is transferred to the browser by the icon of the Internet shortcut file in the Explorer screen of Windows (registered trademark) or the Finder screen of Mac being clicked on or via a user interface which is provided by a PC application such as album software or Device Stage.

Then, the browser is connected to the product registration server 300B in accordance with the scheme name and the host name (and further including the path name as appropriate) included in the Internet shortcut file. Then the information and the check code which are described in accordance with the HTTP GET writing method is uploaded to the product registration server 300B. Here, the product serial number of the digital camera 100 and the operation information code which is the indicating of the intention of the user is embedded in the Internet shortcut file in accordance with the HTTP GET writing method.

The product registration server 300B determines whether or not to distribute the software module with regard to the digital camera 100 in accordance with, for example, the process sequence shown in FIG. 13 when the product serial number of the digital camera 100 and the operation information is received from the browser of the user.

Next, the latter half of the sequence will be described while referencing FIG. 14B. If the determination result is affirmative, the software module for adding a function to the firmware is transferred to the PC 200.

The transferring of the software is performed, for example, via a download page by the browser of the PC 200 being lead to the download page. Here, it is assumed that the additional software module is, for example, a “camera connection PC application”. The PC 200 transfers the software module to the digital camera 100 using USB communication having confirmed that the digital camera 100 which is the origin of the request is the target product which is able to add the software module. This confirmation is equivalent to the operation of a user clicking on the anchor of the software module of the target product on a browser screen. The downloading of the software module is performed at a cost or for free.

Then, the digital camera 100 integrates the received software module into the firmware after having confirmed the received software module. For example, it is confirmed whether the model or the product serial number of the digital camera 100 matches the model or the product serial number of the target product of the additional software module.

When the integration of the software module is successful, it is possible for the digital camera 100 to use the additional function from a point in time when the USB connection with the PC 200 is cut off.

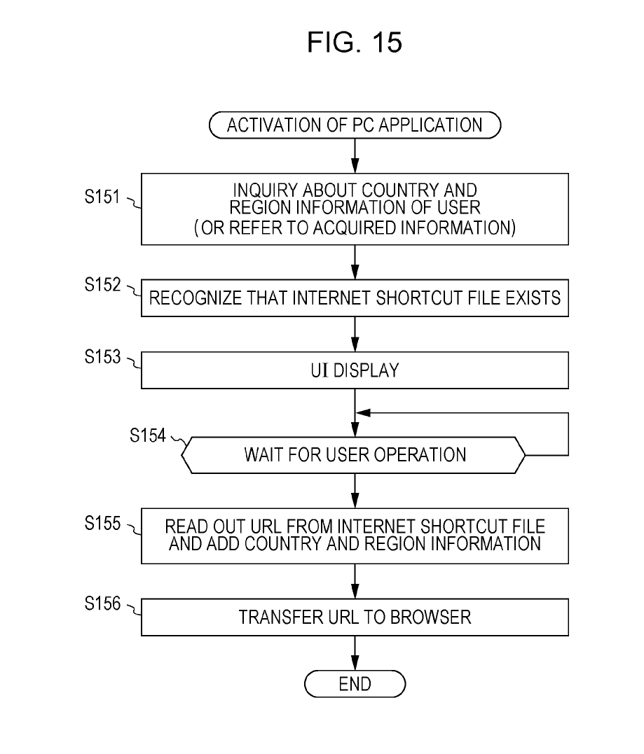

In the PC 200, that it is possible to use the Internet shortcut file via the PC application built into the digital camera 100 such as the album software is as already described (for example, refer to FIG. 3). In a flowchart format, FIG. 15 illustrates a process sequence for the PC 200 to use the Internet shortcut file for product registration using the PC application built into a camera.

When the PC application built into a camera is activated on the PC 200, there is an inquiry of the setting information such as the country and region code, the language code, and the like which is set in the software via USB communication (step S151).

Next, it is confirmed whether or not there is the Internet shortcut file in the USB mass storage region in the digital camera 100 which is USB connected (step S152). Here, the process in a case where the Internet shortcut file does not exist is omitted in order to simplify the description.

Next, a user interface of the PC application built into a camera as shown in FIG. 3 is displayed on a display screen (step S153) and there is waiting for a user operation until the “product registration (R)” button in the dialog which is displayed in the pop-up is selected (step S154).

Then, when the “product registration (R)” button in the dialog is selected, the URL character string is read out from the Internet shortcut file in the USB mass storage region and the setting information such as the country and region code, the language code, and the like which are acquired previously in step S151 is added to the GET parameters in the URL character string (step S155).

After that, when the URL is transferred to the browser (step S156), the sorting server 300A appropriately redirects the URL and access to the product registration server 300B is possible.

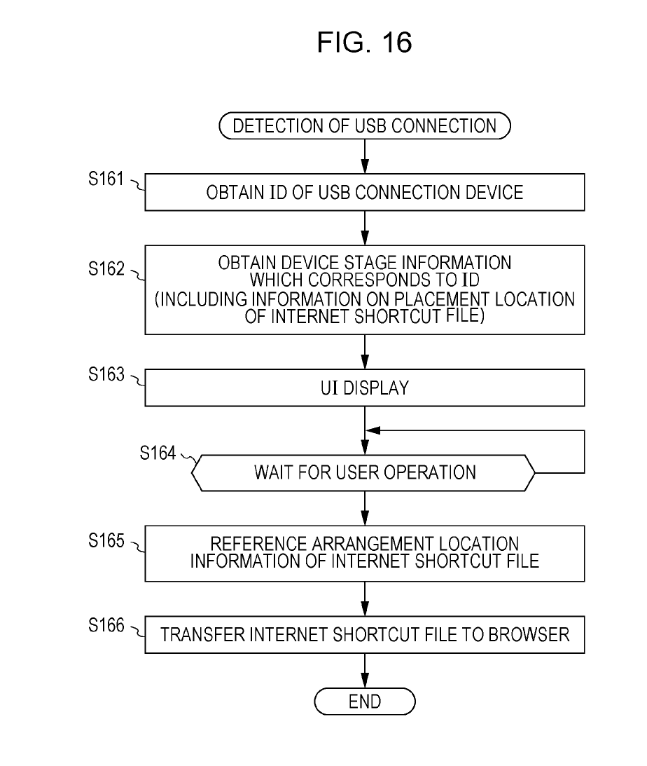

In addition, in a case where the PC 200 has Windows (registered trademark) installed as a platform, that it is possible to use the Internet shortcut file via the “Device Stage” function is as already described (for example, refer to FIG. 4). In a flowchart format, FIG. 16 illustrates a process sequence for the PC 200 to use the Internet shortcut file for product registration using the Device Stage function on Windows (registered trademark).

When the USB connection of the PC 200 to the digital camera 100 is detected, the process sequence is activated. First, ID information of the digital camera 100 which is USB connected is acquired (step S161).

Next, the Device Stage information which corresponds to the acquired ID is acquired (step S162). The Device Stage information includes information on the placement location of the Internet shortcut file in the USB mass storage region.

Next, the user interface which is formed from a menu screen of Device Stage such as that shown in FIG. 4 is displayed on the display screen (step S163). Then, there is waiting for a user operation until the “product registration” anchor on the menu screen is clicked (step S164).

Then, when the “product registration” anchor is clicked, the information on the placement location of the Internet shortcut file in the USB mass storage region is referenced (step S165). Then, the Internet shortcut file is transferred to the browser (step S166). The browser executes a process where there is access to the sorting server 300A and the product related information is registered in accordance with the URL character string which is described in the Internet shortcut file.

As is understood from the description up until here, according to the embodiment, in the information communication system shown in FIG. 1, it is possible to upload product information from a PC connected to an information apparatus via a cable according to a simple user operation which does not depend on a PC platform without burdening a memory capacity of the information apparatus.

It should be understood by those skilled in the art that various modifications, combinations, sub-combinations and alterations may occur depending on design requirements and other factors insofar as they are within the scope of the appended claims or the equivalents thereof.

What is claimed is:

1. An information communication system comprising:
a product registration server which registers product information so as to correspond with user information;
a portable information apparatus which has an Internet shortcut file which includes a URL of the product registration server and the product information; and
an information processing device which activates a browser based on the read-out Internet shortcut file when externally connected to the portable information apparatus and accesses the product registration server.

2. The information communication system according to claim 1,
wherein the Internet shortcut file includes a check code of the product information, and
the product registration server performs the product information registration after authenticity has been confirmed on the basis of the check code.

3. The information communication system according to claim 1,
wherein the Internet shortcut file includes operation information code which indicates an intention of a user to add a function to the portable information device, and
the product registration server transfers a software module which adds a function, where the intention to add the function is indicated in the operation information code, to the information processing device so as for the information processing device to transfer the received software module to the portable information apparatus.

4. The information communication system according to claim 1,
wherein the product registration server limits the number of times a service is provided to the portable information apparatus.

5. The information communication system according to claim 1,
wherein the Internet shortcut file includes a time stamp, and
the product registration server limits the number of times a service is provided to the portable information apparatus based on the time stamp.

6. A portable information apparatus comprising:
a connection interface which is externally connected to an information processing device;
a first internal memory which stores a URL of the product registration server and product information and which is not able to be accessed by the information processing device via the connection interface;
a second internal memory which is able to be accessed by the information processing device via the connection interface; and
a processing section which generates an Internet shortcut file on the basis of the URL of the product registration server and the product information which are stored in the first internal memory, stores the Internet shortcut file in the first internal memory, and copies the Internet shortcut file in the first internal memory into the second internal memory in response to the information processing device being connected to the connection interface.

7. The portable information apparatus according to claim 6,
wherein the processing section generates a check code of the product information and includes the check code in the Internet shortcut file.

8. The portable information apparatus according to claim 6,
wherein the processing section includes an operation information code which indicates an intention to add a function in the Internet shortcut file.

9. The portable information apparatus according to claim 6,
wherein the processing section includes a time stamp in the Internet shortcut file.

10. The portable information apparatus according to claim 6,
wherein the processing section changes the Internet shortcut file in the first internal memory when the Internet shortcut file is not placed in the second internal memory or when the size or the time stamp of the Internet shortcut file which is already placed in the second internal memory is different from the Internet shortcut file stored in the first internal memory.
